(19) United States
(12) Patent Application Publication
(10) Pub. No.: US 2006/0135217 A1
(43) Pub. Date: Jun. 22, 2006

(54) ALERTING METHOD FOR RECHARGING MOBILE DEVICES

(76) Inventors: Chia-chi Sung, San Diego, CA (US); Steven D. Cheng, San Diego, CA (US)

Correspondence Address: NORTH AMERICA INTELLECTUAL PROPERTY CORPORATION, P.O. BOX 506, MERRIFIELD, VA, 22116, US

(21) Appl. No.: 10/905,181

(22) Filed: Dec. 20, 2004

(51) Int. Cl. H04M 1/00

(52) U.S. Cl. 455/573; 455/567

(57) ABSTRACT

An alerting method for recharging a battery of a mobile device. The method includes collecting measured data with the mobile device, comparing the measured data with a statistic model of recharging patterns of the mobile device, determining if it is currently a suitable time for charging the battery of the mobile device according to a predetermined relation in the statistic model, and alerting a user of the mobile device to recharge the battery if it is currently a suitable time for charging the battery of the mobile device.

### BACKGROUND OF INVENTION

1. Field of the Invention

The present invention relates to a recharging method, and more specifically, to a method for alerting users to recharge batteries of mobile devices.

2. Description of the Prior Art

Mobile devices usually use rechargeable batteries as their power source. When the battery used in a mobile device is exhausted, it needs to be recharged immediately or the mobile device will no longer operate. In order to prevent the battery from becoming completely exhausted, mobile devices often remind the users when their battery capacity is low. However, users are not always able to recharge the battery right away. For example, users may sometimes find themselves traveling on the road and performing important activities on their mobile devices when the low battery alert suddenly comes up. In this case, the users are aware of the problem, but can still do nothing about it. Some users bring one or several backup batteries to solve the problem, but this takes a lot of effort to make sure the backup batteries are always charged.

### SUMMARY OF INVENTION

It is therefore an objective of the claimed invention to provide a method for alerting users to recharge a battery of a mobile device in order to solve the above-mentioned problems.

According to the claimed invention, an alerting method for recharging a battery of a mobile device is proposed. The method includes collecting measured data with the mobile device, comparing the measured data with a statistic model of recharging patterns of the mobile device, determining if it is currently a suitable time for charging the battery of the mobile device according to a predetermined relation in the statistic model, and alerting a user of the mobile device to recharge the battery if it is currently a suitable time for charging the battery of the mobile device.

It is another objective of the claimed invention to provide a battery recharging apparatus for a mobile device. The battery recharging apparatus includes a data collecting device for collecting measured data, a memory for storing a statistic model of recharging patterns of the mobile device, and a logic circuit for comparing the measured data with the statistical model and for determining if it is currently a suitable time for charging a battery of the mobile device according to a predetermined relation in the statistic model. If it is currently a suitable time for charging the battery of the mobile device, an alert module alerts a user of the mobile device to recharge the battery.

It is an advantage of the claimed invention that the user is alerted when it is a suitable time for charging the battery. The present invention alerts the user when there is a convenient opportunity for the user to charge the battery. Therefore, the battery does not have to be nearly exhausted of energy before an alert will be given, and the user has a convenient opportunity to charge the battery before the battery is fully exhausted.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a mobile device according to the present invention.

FIG. 2 to FIG. 7 are block diagrams of mobile devices with data collecting devices according to various embodiments of the present invention.

### DETAILED DESCRIPTION

The present invention collects a variety of kinds of data related to the battery of a mobile device, and compares this data to the recharging patterns of the user of the mobile device. Data is collected periodically, and over time a statistical model is trained based on the user's habits. If the user frequently charges the battery of the mobile device in the same place, at the same time, or prefers to switch to spare batteries, these events will be recorded in the statistical model.

Every time new information comes in, the information is first used to decide a hypothesis of whether it is a good time for the user to recharge the battery based on the statistical model. The new information itself is then combined into the model. After the user uses the mobile device for some time, the mobile device learns the user's recharging preferences and can issue a recharging alert if the user forgets to recharge the battery.

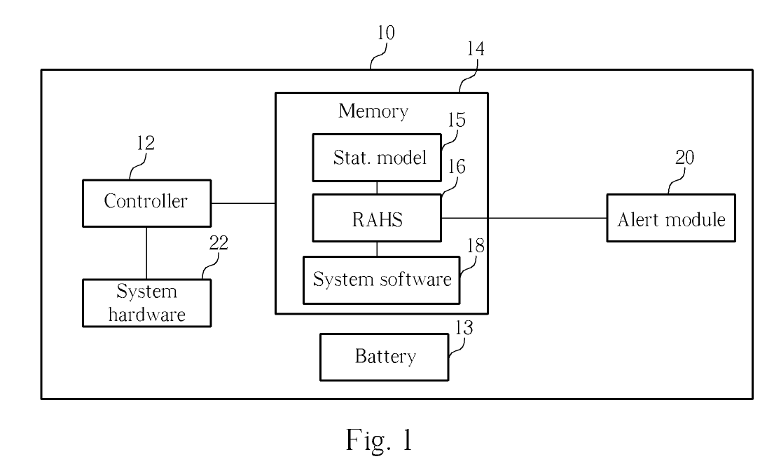

Please refer to FIG. 1. FIG. 1 is a block diagram of a mobile device 10 according to the present invention. The mobile device 10 contains a memory 14, which stores a statistical model 15, a recharging alert hypothesis subsystem (RAHS) 16, and system software 18. The RAHS 16 analyzes data measured by the mobile device 10, compares the data with records contained in the statistical model 15, and generates an alert with an alert module 20 if the RAHS 16 determines that it is currently a suitable time for recharging a battery 13 of the mobile device 10. The mobile device 10 also contains a controller 12 for controlling operation of system hardware 22 of the mobile device 10 and for executing the system software 18. The disclosure below describes several data collecting devices of the mobile device 10 which utilize different kinds of data for determining if it is a suitable time for recharging the battery 13 of the mobile device 10.

For convenience, a mobile phone will serve as an example of the mobile device 10 for use with the present invention. Please note that the present invention may also be used in a variety of other mobile devices besides mobile phones so long as the mobile devices contain one or more of the data collecting devices explained below.

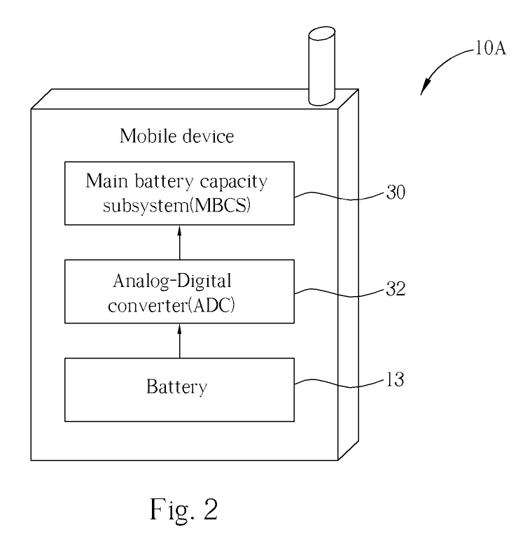

Please refer to FIG. 2. FIG. 2 is a block diagram of a mobile device 10A with a data collecting device according to a first embodiment of the present invention. An analog-digital converter (ADC) 32 converts an analog value (such as the voltage of the battery 13) representing the remaining capacity of the battery 13 into a digital value. The ADC 32 then provides this digital value to a main battery capacity subsystem (MBCS) 30. The MBCS 30 compares the digital value to values stored in a lookup table, and determines the estimated remaining capacity of the battery 13. The remaining capacity of the battery 13 is used in determining if it is a suitable time for recharging the battery 13. For example, the battery 13 would ordinarily not be recharged when the capacity is still full.

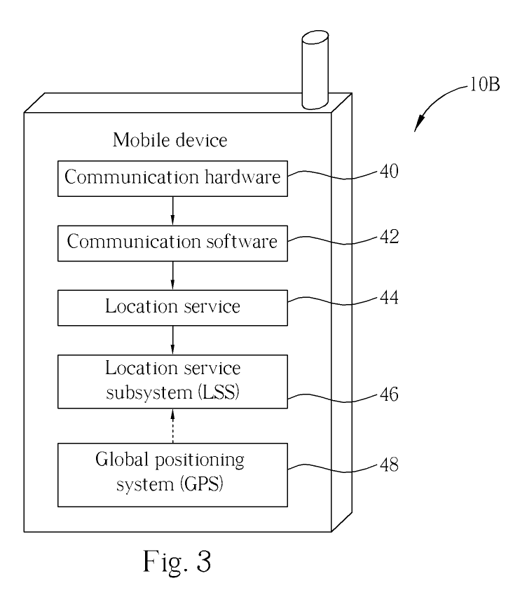

Please refer to FIG. 3. FIG. 3 is a block diagram of a mobile device 10B with a data collecting device according to a second embodiment of the present invention. The mobile device 10B contains a location service subsystem LSS 46 for determining the location of the mobile device 10B. The LSS 46 receives location data from a location service circuit 44. The location service circuit 44 calculates the location of the mobile device 10B based off of measurements from the nearest base stations. Alternatively, the public line mobile network (PLMN) may provide the location data to the mobile device 10B directly. In either situation, the location data is received through communication hardware 40 of the mobile device 10B, and provided to the location service circuit 44 through communication software 42. Instead of receiving location data from the PLMN or by calculating using base station signals, a global positioning system (GPS) circuit 48 may also be used to provide the location of the mobile device 10. A dotted line connecting the GPS circuit 48 and the LSS 46 indicates that the GPS circuit 48 is optional. The location information is a good indication of recharging availability because a user usually only recharges the battery 13 in a few different places like the home or the office.

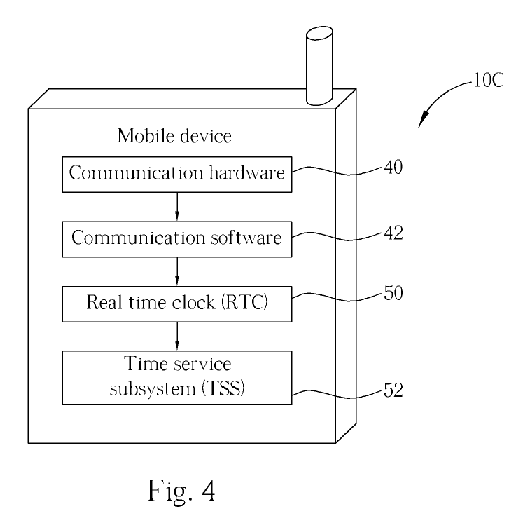

Please refer to FIG. 4. FIG. 4 is a block diagram of a mobile device 10C with a data collecting device according to a third embodiment of the present invention. Most mobile phones, and many mobile devices have a real time clock (RTC) circuit 50 built into the hardware. The RTC circuit 50 runs continuously, and is synchronized with the local time when the mobile device 10C receives radio signals from a base station. The communication hardware 40 receives the time data from the base station, and passes this time data on to the RTC circuit 50 using the communication software 42. The RTC circuit 50 provides the time information to a time service subsystem (TSS) 52. A user's recharging activity is often very closely correlated with a particular time of day. A user may have a preferred time of the day to recharge the battery 13, such as during the night, and knowing this information helps to decide the best time to alert the user.

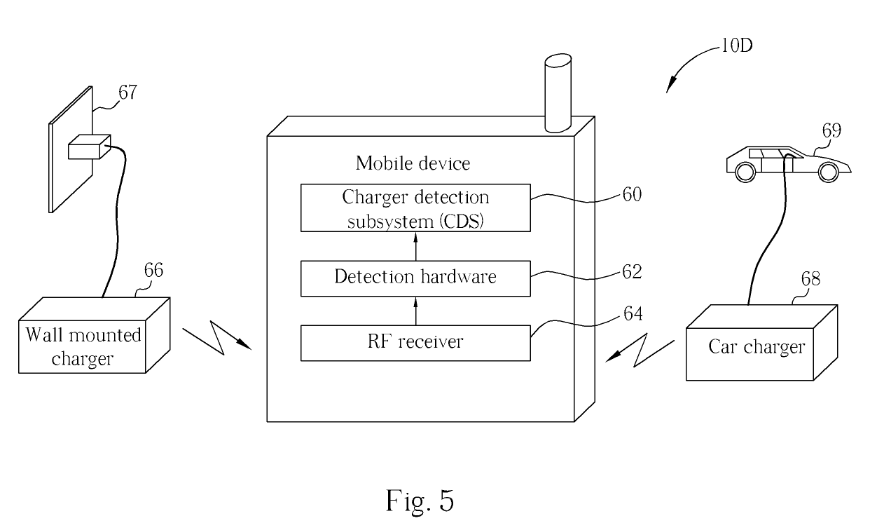

Please refer to FIG. 5. FIG. 5 is a block diagram of a mobile device 10D with a data collecting device according to a fourth embodiment of the present invention. The mobile device 10D makes use of battery chargers 66 and 68 that transmit radio signals periodically to identify themselves. The battery charger 66 may be a wall mounted charger that is plugged into a wall outlet 67. The battery charger 68 may be a car charger that is plugged into a cigarette lighter of a car 69. The radio signal strength of each of the battery chargers 66 and 68 is preferably set such that the radio signals will only be received by the mobile device 10D when the mobile device 10D is within a short distance, such as 50 m, of the battery chargers 66 and 68. When the mobile device 10D receives the radio signals from one or more of the battery chargers 66 and 68, the mobile device 10D knows that a charger is nearby. The mobile device 10D will then analyze information contained in the radio signal to determine if the charger is compatible with the battery 13 of the mobile device 10D.

The mobile device 10D contains a radio frequency (RF) receiver 64 for receiving the radio signals from the battery chargers 66 and 68. The RF receiver 64 send the radio signals to detection hardware 62, which analyzes the information stored in the radio signals. Finally, the detection hardware 62 provides information about the battery chargers 66 and 68 to a charger detection subsystem (CDS) 60.

When a charger is charging the battery 13, it will inform the mobile device 10D. In some mobile device designs, the charger is directly connected to the mobile device 10D for recharging the battery 13. For this kind of design, the mobile device 10D controls the recharging process and already knows when the recharging begins and ends. In other designs, the charger only connects to the battery 13. In that case, the charger needs to transmit a radio signal to inform the mobile device 10D of the recharging status.

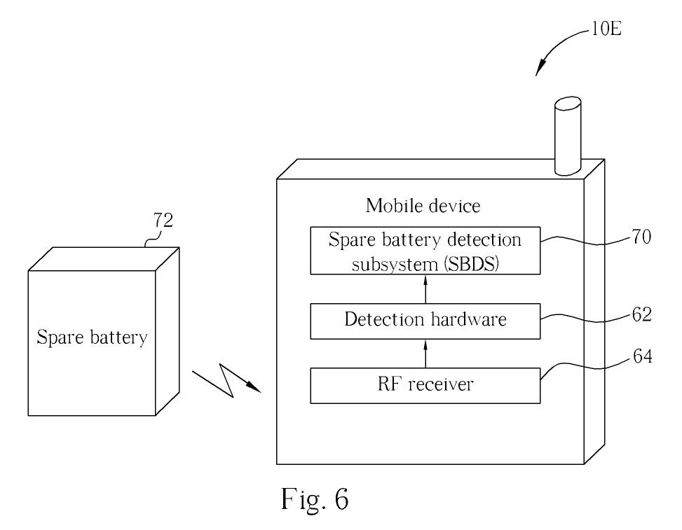

Please refer to FIG. 6. FIG. 6 is a block diagram of a mobile device 10E with a data collecting device according to a fifth embodiment of the present invention. In this embodiment, a spare battery 72 will broadcast radio signals. The RF receiver 64 of the mobile device 10E receives these radio signals, and provides the signals to the detection hardware 62. The detection hardware 62 analyzes information contained in the radio signals to determine if the spare battery 72 is compatible with the mobile device 10E. The detection hardware 62 provides this information to a spare battery detection subsystem (SBDS) 70.

If one or more spare batteries 72 are in close proximity to the mobile device 10E, the spare batteries 72 will identify themselves and their remaining capacity. Since batteries, unlike chargers, are limited in energy, they will transmit radio signals at lower signal strength and for a much longer period. If the spare battery 72 is already out of energy, it will not have the power to transmit radio signals. This is not a problem because the mobile device 10E does not distinguish between an exhausted spare battery and no spare battery at all.

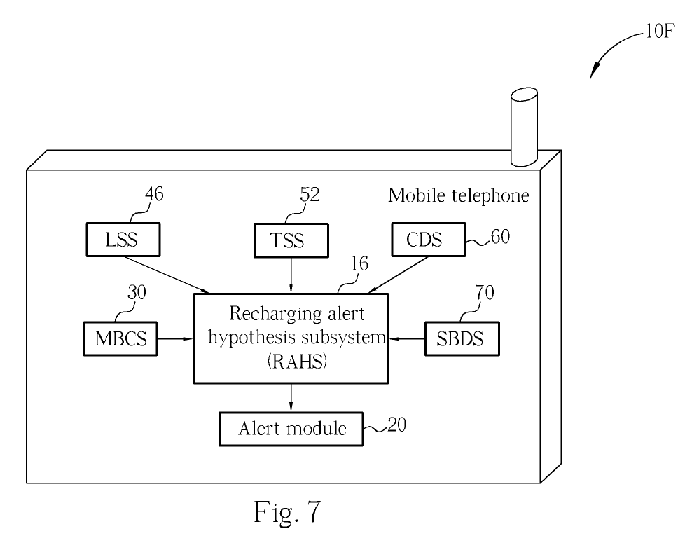

Please refer to FIG. 7. FIG. 7 is a block diagram of a mobile device 10F with a data collecting device according to a sixth embodiment of the present invention. The RAHS 16 collects data from the MBCS 30, the LSS 46, the TSS 52, the CDS 60, and the SBDS 70, compares this data with records contained in the statistical model 15, and generates an alert with the alert module 20 if the RAHS 16 determines that it is currently a suitable time for recharging a battery 13 of the mobile device 10. Using the statistical model 15, one of two hypotheses is chosen when new information comes in. The two hypotheses are, H₀ and H₁, where H₀ represents that it is currently not a good time for the user to recharge the battery and H₁ represents that it is currently a good time for the user to recharge the battery.

The rule used to choose between these two hypotheses is called Neyman-Pearson decision rule. To use this rule the user needs to select a maximum value α for a false positive probability P_{f}. P_{f} is the probability that H₁ is chosen when H₀ should be chosen, which for this invention means the likelihood that the user is alerted to recharge when it is actually not a good time for recharging. By decreasing α, the user can elect to be bothered less by the mobile device 10E at the expense of missing more recharging opportunities, and vice versa.

The algorithm performed by the RAHS 16 can be described in the following steps:

1. At time t, the RAHS 16 reads data vector xₜ containing collected data from the MBCS 30, the LSS 46, the TSS 52, the CDS 60, and the SBDS 70.

2. At time t, the RAHS 16 reads hₜ, which is an observed outcome, from the CDS 60 about whether there is recharging taking place.

3. Collected data x₀, x₁, . . . , xₜ₋₁ and observed outcomes h₀, h₁, hₜ₋₁ are combined to establish two conditional probabilities, P(X|H₀) and P(X|H₁).

4. A decision rule outcome D_{γ} is determined to be H₁ when {P(xₜ|H₁)/P(xₜ|H₀)}>γ and determined to be H₀ when {P(xₜH₁)/P(xₜ|H₀)}<γ. The threshold γ is chosen such that P_{f}=P(D_{γ}=H₁|H₀)<α and P(D_{γ}=H₀|H₁)<=P(D=H₀|H₁) are always true for x₀, x₁, . . . , xₜ₋₁ and h₀, h₁, . . . , hₜ₋₁.

5. The RAHS 16 initiates the recharging alert if D_{γ}=H₁, and does nothing if D_{γ}=H₀.

The above algorithm for determining when to alert the user of opportunities to charge the battery 13 is given as an example only. It will be appreciated that numerous other algorithms can also be used that take into account collected data received from one or more of the MBCS 30, LSS 46, TSS 52, CDS 60, and SBDS 70 subsystems.

In summary, the present invention alerts the user of the mobile device when it is a suitable time for charging the battery in response to data collected. The decision to alert the user is based on the current battery level, the location of the mobile device, the current time, and the location of nearby charging devices or spare batteries. By consulting the user's past recharging behavior when making alerting decisions, the mobile device can intelligently inform the users of optimum and convenient times to recharge the battery of the mobile device.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An alerting method for recharging a battery of a mobile device, the method comprising:
collecting measured data with the mobile device;
comparing the measured data with a statistic model of recharging patterns of the mobile device;
determining if it is currently a suitable time for charging the battery of the mobile device according to a predetermined relation in the statistic model; and
alerting a user of the mobile device to recharge the battery if it is currently a suitable time for charging the battery of the mobile device.

2. The method of claim 1 wherein collecting measured data with the mobile device comprises determining the location of the mobile device, the statistical model containing information specifying locations in which the battery of the mobile device is commonly charged.

3. The method of claim 1 wherein collecting measured data with the mobile device comprises determining the current local time, the statistical model containing information specifying times in which the battery of the mobile device is commonly charged.

4. The method of claim 1 wherein collecting measured data with the mobile device comprises detecting wireless signals broadcast by nearby battery charging devices, the statistical model containing information specifying which battery charging devices are compatible with the battery of the mobile device.

5. The method of claim 1 wherein collecting measured data with the mobile device comprises detecting wireless signals broadcast by nearby spare batteries, the statistical model containing information specifying which spare batteries are compatible with the mobile device.

6. The method of claim 1 wherein the predetermined relation in the statistic model is defined by a decision rule outcome D_{γ}, the decision rule outcome D_{γ} being equal to H₁ when {P(xₜ|H₁)/P(xₜ|H₀)}>γ and being equal to H₀ when {P(xₜ|H₁)/P(xₜ|H₀)}<γ, wherein H₁ represents that it is currently a suitable time for charging the battery of the mobile device, H₀ represents that it is not currently a suitable time for charging the battery of the mobile device, and the threshold γ is chosen such that P(D_{γ}=H₁|H₀)<α, α being a constant representing a coefficient of false positive occurrences.

7. The method of claim 1 wherein the mobile device is a mobile phone.

8. A battery recharging apparatus for a mobile device, comprising:
a data collecting device for collecting measured data;
a memory for storing a statistic model of recharging patterns of the mobile device;
a logic circuit for comparing the measured data with the statistical model and for determining if it is currently a suitable time for charging a battery of the mobile device according to a predetermined relation in the statistic model; and
an alert module for alerting a user of the mobile device to recharge the battery if it is currently a suitable time for charging the battery of the mobile device.

9. The apparatus of claim 8 wherein the data collecting device is a location service subsystem for determining the location of the mobile device, the statistical model containing information specifying locations in which the battery of the mobile device is commonly charged.

10. The apparatus of claim 9 further comprising a global positioning system (GPS) subsystem for providing location information to the location service subsystem.

11. The apparatus of claim 8 wherein the data collecting device is a time service subsystem for determining the current local time, the statistical model containing information specifying times in which the battery of the mobile device is commonly charged.

12. The apparatus of claim 11 further comprising a real time clock for providing local time information to the time service subsystem.

13. The apparatus of claim 8 wherein the data collecting device is a charger detection subsystem for detecting wireless signals broadcast by nearby battery charging devices, the statistical model containing information specifying which battery charging devices are compatible with the battery of the mobile device.

14. The apparatus of claim 13 further comprising a radio frequency (RF) receiver for receiving the wireless signals and providing data contained in the wireless signals to the charger detection subsystem.

15. The apparatus of claim 8 wherein the data collecting device is a spare battery detection subsystem for detecting wireless signals broadcast by nearby spare batteries, the statistical model containing information specifying which spare batteries are compatible with the mobile device.

16. The apparatus of claim 15 further comprising a radio frequency (RF) receiver for receiving the wireless signals and providing data contained in the wireless signals to the spare battery detection subsystem.

17. The apparatus of claim 8 wherein the predetermined relation in the statistic model is defined by a decision rule outcome D_{γ}, the decision rule outcome D_{γ} being equal to H₁ when {P(xₜ|H₁)/P(xₜ|H₀)}>γ and being equal to H₀ when {P(xₜ|H₁)/P(xₜ|H₀)}<γ, wherein H₁ represents that it is currently a suitable time for charging the battery of the mobile device, H₀ represents that it is not currently a suitable time for charging the battery of the mobile device, and the threshold γ is chosen such that P(D_{γ}=H₁|H₀)<α, α being a constant representing a coefficient of false positive occurrences.

18. The apparatus of claim 8 wherein the mobile device is a mobile phone.
